(19) United States
(12) Patent Application Publication
(10) Pub. No.: US 2026/0249221 A1
(43) Pub. Date: Aug. 27, 2026

(54) RING FILTER ELEMENT ASSEMBLY INCLUDING TWO RING FILTER ELEMENTS ROTATIONALLY ALIGNED RELATIVE TO EACH OTHER

(71) Applicant: MANN+HUMMEL GmbH, Ludwigsburg (DE)

(72) Inventors: Pascal NEEF, Trossingen (DE); Philipp HETTKAMP, Steinheim (DE); Johannes GRAD, Simbach (DE); Pedro Miguel PEREIRA MADEIRA, Bietigheim-Bissingen (DE); Eva HALLBAUER, Himmelkron (DE); Peter PEKNY, Neuenmarkt (DE); Andreas WEBER, Freiberg (DE); Christoph WITTMERS, Bietigheim-Bissingen (DE); Steffen GERLACH, Nufringen (DE); Mario RIEGER, Ludwigsburg (DE); Markus HANSELMANN, Lauffen (DE); Friedrich KUPFER, Marklkofen (DE); Dieter WEISS, Gefrees (DE); Daniel SCHMID, Sachsenheim (DE); Dennis STARK, Mauer (DE)

(21) Appl. No.: 19/649,541

(22) Filed: Apr. 16, 2026

Related U.S. Application Data
(63) Continuation of application No. PCT/EP2024/079186, filed on Oct. 16, 2024.

(30) Foreign Application Priority Data
Oct. 23, 2023 (DE) 10 2023 129 017.7

(51) Int. Cl. B01D 46/00; B01D 46/52; B01D 46/64

(52) U.S. Cl. CPC B01D 46/0036; B01D 46/0005; B01D 46/522; B01D 46/64; B01D 2265/026

(57) ABSTRACT

A ring filter element assembly includes a first ring filter element with a first filter medium body and a second ring filter element with a second filter medium body, the second ring filter element is arranged inside the first ring filter element. An outer wall surface of the second filter medium body and an inner wall surface of the first filter medium body adjoin each other in an interface region and a positioning device arranged therein angularly positions the first and second ring filter elements relative to each other. The positioning device has an engagement element extending radially outwardly to engage a first counter engagement element of the first ring filter element and/or radially inwardly to engage a second counter engagement element of the second ring filter element. The assembly may be positioned in a filter housing of a filter device provided with housing positioning devices.

### CROSS-REFERENCE TO RELATED APPLICATIONS

This application is a continuation application of international application No. PCT/EP 2024/079186 having an international filing date of Oct. 16, 2024, and designating the United States, the international application claiming a priority date of Oct. 23, 2023, based on prior filed German patent application No. 10 2023 129 017.7, the entire contents of the aforesaid applications being incorporated herein by reference to the fullest extent permissible.

### BACKGROUND

The invention concerns a ring filter element assembly for arrangement in a filter housing, including a first ring filter element and a second ring filter element, each including a filter medium body surrounding an interior, wherein the second ring filter element is received at least partially in the interior of the filter medium body of the first ring filter element, wherein an outer wall surface of the filter medium body of the second ring filter element and an inner wall surface of the filter medium body of the first ring filter element adjoin each other in an interface region.

Such a ring filter element assembly is disclosed in WO 2015/092681 A1.

In various applications, it may be required to guide a fluid to be filtered, for example air, sequentially through two different filter media in order to remove troublesome components from the fluid. For a space-saving configuration, two ring-shaped filter medium bodies may be employed, wherein one of the filter medium bodies is arranged in the interior of the other filter medium body.

In this context, it is important that ring filter elements are used which match each other and are suitable for the respective application. In addition, it is often important that the two ring filter elements are correctly aligned relative to each other. For example, mass air flow sensors react often sensitively to a changed alignment of filter elements. This applies substantially also to rotation-symmetrical ring filter elements including certain manufacturing-caused deviations from the rotational symmetry when they are assembled in different rotational positions.

US 2021/0069630 A1 describes a filter element with a filter bellows which extends along a longitudinal axis and surrounds an interior. The filter bellows is formed of a folded filter material that is arranged on a support tube. The filter bellows may be configured as a round filter element. At an end face first end and an oppositely positioned end face second end of the filter element, end discs are arranged which seal the filter bellows at its end face edges. The filter bellows includes at both of its ends an external notch, respectively, whose axial length is shorter in direction of the longitudinal axis than the length extension of the filter bellows. The notches are locally limited and do not extend across the entire length of the folded bellows. For example, the notches have the largest fold edge spacing at the respective end discs and taper with increasing spacing from the end disc. The notches widen the spacing between two neighboring folds, wherein the folds as a whole extend across the entire length of the folded bellows. The notches permit a position-precise installation of the filter element in a housing.

US 2019/0308125 A1 discloses a round filter element including a filter medium body whose wall may be flowed through by the fluid to be purified in radial direction, wherein at or adjacent to an end face a circumferentially extending seal carrier is arranged which is the carrier of a positioning element for form-fit connection to a correlated housing-side counter positioning element.

EP 2 535 550 A2 discloses a ring filter element, for example for a filter device of a fresh air device of an internal combustion engine, including a ring-shaped filter body of a folded web material. End folds that adjoin each other in the circumferential direction are connected directly or indirectly to each other for forming a connection region suitable for rotational position alignment of the filter element. In the connection region, a radially outwardly open longitudinal groove may be formed which for example may be easily felt from the exterior and, for example, enables a forced alignment. As an alternative, a radially inwardly open longitudinal groove may be provided in the connection region. The respective groove base of the longitudinal groove may be formed, for example, by the end folds that are contacting each other. At a housing, an alignment contour is formed which upon insertion of the ring filter element interacts with the connection region in order to force in this way a predetermined rotational position of the ring filter element within the housing.

The already mentioned WO 2015/092681 A1 describes a filter element with two layers of filter material of folded paper that includes a cylindrical shape. The two layers of filter material are non-detachably held at each other in that they are embedded in sections in seals of plastic material. The seals may be arranged in the manner of end discs at the two end faces of the filter element.

It is an object of the invention to ensure that two ring filter elements engaging each other are rotationally aligned relative to each other.

### SUMMARY

This object is solved by a ring filter element assembly for arrangement in a filter housing, for example for air filtration, for example for filtration of the intake air of a fuel cell, including a first ring filter element and a second ring filter element, each including a filter medium body surrounding an interior, wherein the second ring filter element is received at least partially in the interior of the filter medium body of the first ring filter element, wherein an outer wall surface of the filter medium body of the second ring filter element and an inner wall surface of the filter medium body of the first ring filter element adjoin each other in an interface region, wherein in the interface region a positioning device for, for example unequivocal, relative angular positioning of the two ring filter elements relative to each other is arranged and wherein the positioning device includes an engagement element, wherein the engagement element extends radially inwardly and engages a corresponding counter engagement element of the second ring filter element and/or extends radially outwardly and engages a corresponding counter engagement element of the first ring filter element.

This object is further solved by a filter device including a filter housing with at least one fluid inlet and at least one fluid outlet and a ring filter element assembly in accordance with the invention, which is arranged in the filter housing and separates the fluid inlet from the fluid outlet.

This object is also solved by a use of a filter device according to the invention as a cathode air filter of a fuel cell.

This object is also solved by a use of a ring filter element including a filter medium body, surrounding an interior and including at its inner wall surface a counter engagement element, as a first ring filter element of a filter device according to the invention, wherein the engagement element of the positioning device extends radially outwardly into the counter engagement element of the first ring filter element.

This object is also solved by a use of a ring filter element including a filter medium body, surrounding an interior and including at its outer wall surface a counter engagement element, as a second ring filter element of a filter device according to the invention, wherein the engagement element of the positioning device extends radially inwardly into the counter engagement element of the second ring filter element.

This object is also solved by a ring filter element for a filter device according to the invention, including a filter medium body surrounding an interior, wherein the filter medium body includes a folded bellows which is provided at an inner wall surface with a fold expansion.

Embodiments are disclosed in the following further description and the accompanying drawings.

According to the invention, a ring filter element assembly including a first ring filter element and a second ring filter element is provided. For use, the ring filter element assembly may be arranged in a filter housing. The ring filter element assembly is configured for example for air filtration. For example, the ring filter element assembly is configured for filtration of the intake air of a fuel cell. For example, the ring filter element assembly may be used as a cathode air filter of a fuel cell.

The first ring filter element and the second ring filter element each include a filter medium body surrounding an interior. The two ring filter elements are thus closed in circumferential direction.

For example, the two ring filter elements may be flowed through in series (sequentially). For example, the ring filter element assembly may be flowed through radially from the exterior to the interior. As an alternative, a flow from the interior to the exterior in radial direction may be provided.

The second ring filter element is at least partially received in the interior of the filter medium body of the first ring filter element. In other words, the first ring filter element surrounds the second ring filter element at least in an axial subregion. In this way, a compact ring filter element assembly is obtained. Typically, the two ring filter elements are arranged detachably at each other. They may then be exchanged individually.

The first ring filter element is referred to in the following also as outer ring filter element; correspondingly, the second ring filter element is referred to in the following also as inner ring filter element. The filter medium body of the first ring filter element is also referred to as first or outer filter medium body; the filter medium body of the second ring filter element is also referred to as second or inner filter medium body.

A longitudinal axis of the respective filter medium body may extend through its interior. In other words, the filter medium body may surround the longitudinal axis in a ring shape. For example, a common longitudinal axis of the two ring filter elements extends through the interior of their filter medium bodies. In other words, the two filter medium bodies may be arranged coaxially to each other. Directional specifications such as radial or axial relate to the common, longitudinal axis. Also, an angular position of the ring filter elements may be determined in relation to the common longitudinal axis.

An outer wall surface of the filter medium body of the second ring filter element and an inner wall surface of the filter medium body of the first ring filter element adjoin each other in an interface region. The interface region includes thus the region in which the first ring filter element surrounds the second ring filter element. Herein, “adjoining each other” encompasses a direct as well as an indirect neighboring arrangement of the first and of the second ring filter elements and explicitly does not require that the first and the second ring filter elements contact each other but encompasses instead also that additional element(s) may be arranged in the interface region between the first and the second ring filter elements.

According to the invention, it is provided that in the interface region a positioning device is arranged for, for example, unequivocal relative angular positioning of the two ring filter elements relative to each other. Thus, the positioning device ensures that a rotational alignment of the two ring filter elements relative to each other does not change. In this way, the correct alignment of the two ring filter elements relative to each other is ensured. In other words, the positioning device holds the two ring filter elements in a defined angular position relative to each other. In addition, the positioning device permits mounting of the two ring filter elements in only one or a plurality of, for example, up to four, relative angular positions. For example, the positioning device may permit mounting of the two ring filter elements only in a single (unequivocal) relative angular position and secure this angular position.

It is further provided according to the invention that the positioning device includes an engagement element, wherein the engagement element extends radially inwardly and engages a corresponding (second) counter engagement element of the second ring filter element and/or wherein the engagement element extends radially outwardly and engages a corresponding (first) counter engagement element of the first ring filter element. In this way, the desired angular position of the two ring filter elements may be defined relative to each other by form fit and secured. When mounting, the correct alignment may be realized simply in that the two ring filter elements are rotated until the engagement element may be inserted into the counter engagement element or the counter engagement elements.

The engagement element may include a projection or a rib which is pointing radially outwardly and/or radially inwardly. The counter engagement element at the respective ring filter element may be for example a recess, a depression, or a groove. The engagement element and the counter engagement element may extend across the entire length or a subregion of the length of the respective ring filter element. For example, the engagement element may be shorter in axial direction than the corresponding counter engagement element. The engagement element and the counter engagement element are matched to each other (i.e., they correspond with each other) such that a deformation of these elements when being mounted is required only to a minimal extent or for example not required; at the same time, however, only a minimal or for example no rotational clearance occurs. The former reduces the required force expenditure and avoids damages. The latter effects the defined rotational alignment of the two ring filter elements relative to each other. The rotational clearance in relation to a center position may amount to, for example, maximally +/−5°, for example maximally +/−3°, or maximally +/−1°.

When the engagement element engages a respective counter engagement element at both ring filter elements, the engagement element may be typically arranged fixedly at the housing. When the engagement element engages only one counter engagement element of one of the ring filter elements, the engagement element is in principle arranged fixedly at the other ring filter element.

The first and/or the second ring filter element may have a hollow-cylindrical shape. For example, the two ring filter elements or their filter medium bodies may be of a circular ring shape in cross section. Such ring filter elements may be produced efficiently and provide a good installation space utilization. In embodiments, at least one of the ring filter elements may have an oval or elongate oval cross section. As an alternative or in addition, at least one of the ring filter elements may taper along the longitudinal axis. In other words, at least one of the ring filter elements may include an overall conical shape.

At least one of the filter medium bodies of the first and/or second ring filter element, for example the filter medium body of the second ring filter element, may include an adsorbing gas filter medium, for example containing active carbon. In other words, the filter medium of at least one of the filter medium bodies may include an adsorbent. In this way, harmful gases may be removed from the air flow to be filtered and bound in the filter medium body.

The filter medium body of the first ring filter element may include a (first) folded bellows. The first folded bellows or the first filter medium body may be formed, for example, by a filter medium folded in a star shape.

As an alternative or in addition, the filter medium body of the second ring filter element may include a (second) folded bellows. The second folded bellows or the second filter medium body may be formed for example by a filter medium folded in a star shape.

At least one fold of the folded bellows of the first ring filter element may protrude at the inner wall surface farther radially inwardly than folds of the folded bellows adjoining in circumferential direction, wherein the protruding fold forms also at least partially the engagement element and engages the counter engagement element of the second ring filter element. In other words, the radially inner fold edges of a plurality of folds may have the same spacing from the longitudinal axis while the radially inner fold edges of one or a plurality of neighboring folds have a smaller spacing from the longitudinal axis. In this way, the engagement element may be integrated into the folded bellows by a simple variation of the fold pattern.

The engagement element may be arranged at a central tube, which central tube is arranged in the interface region. The central tube extends thus between the outer wall surface of the second ring filter element and the inner wall surface of the first ring filter element. For example, the engagement element is one piece together with the central tube.

In an embodiment, the first ring filter element includes an element-fixed central tube which is arranged at the inner wall surface of the filter medium body of the first ring filter element and is fastened indirectly or directly to the filter medium body of the first ring filter element, wherein the engagement element is arranged at the central tube, for example is one piece together with the central tube, and wherein the engagement element extends radially inwardly and engages the counter engagement element of the second ring filter element. The central tube, on the one hand, supports the filter medium body of the outer ring filter element. On the other hand, the central tube effects the defined rotatory alignment of the inner ring filter element relative to the outer ring filter element.

In an alternative embodiment, the ring filter element assembly includes a central tube which is detachably arranged in the interface region and arranged fixedly at the filter housing in a mounting state as intended, wherein the engagement element is arranged at the housing-fixed central tube and extends radially inwardly into the counter engagement element of the second ring filter element as well as radially outwardly into the counter engagement element of the first ring filter element. In this embodiment, the central tube is fastened, at least in the mounted state, to the filter housing, for example in a defined angular position. For example, the central tube may be locked at the filter housing. The central tube may be connected permanently to a housing part of the filter housing. The two ring filter elements may be arranged detachably at the central tube. This may simplify the manufacture of the ring filter elements. In the mounted state, the two ring filter elements are rotationally aligned relative to the central tube in that the engagement element engages the respective counter engagement elements of both ring filter elements. When the central tube is fastened to the filter housing in a defined angular position, the two filter elements additionally are angularly positioned by means of the central tube relative to the filter housing in the mounted state.

When the engagement element is arranged at a central tube, for example in case of the two aforementioned embodiments, the central tube may include a cutout at the end face for engagement of a housing-fixed axial projection, for example wherein the cutout is formed in the region of the engagement element. In this way, a defined rotational alignment of the central tube in relation to the filter housing may be achieved. The central tube then aligns the two ring filter elements in their angular position relative to each other as well as the two ring filter elements together (angularly positioned relative to each other) in their angular position in relation to the filter housing. The alignment of the ring filter elements is then completely defined, which simplifies the calibration of mass air flow sensors, for example.

When the filter medium body of the first ring filter element includes a folded bellows, the engagement element may engage an intermediate space between two neighboring folds of the folded bellows at the inner wall surface of the filter medium body of the first ring filter element. Thus, the intermediate space of the neighboring folds forms the counter engagement element. This reduces the expenditure for providing the counter engagement element at the first filter medium body. This embodiment is suitable for example when the engagement element is formed at a central tube arrangeable fixedly at the housing with engagement in both ring filter elements. For example, the counter engagement element of the first ring filter element may be formed by a fold expansion. In other words, in the region of the engagement of the engagement element in the outer filter medium body, at least one fold of its folded bellows is provided with a fold expansion. This provides space for the engagement of an engagement element which is wider in circumferential direction. In addition, the locally present fold expansion effects a defined angular position of the first ring filter element relative to the engagement element. The fold angle and/or a fold spacing (spacing of radially inner fold edges measured in circumferential direction) may be larger in the region of the fold expansion at the inner wall surface of the outer ring filter element than that of a plurality of folds of the folded bellows, for example all folds-aside from the region of the fold expansion-may have the same fold angle or fold spacing.

When the filter medium body of the second ring filter element includes a folded bellows, the engagement element may engage an intermediate space between two neighboring folds of the folded bellows at the outer wall surface of the filter medium body of the second ring filter element. Thus, the intermediate space of the neighboring folds forms the counter engagement element. This reduces the expenditure for providing a counter engagement element at the second filter medium body. For example, the counter engagement element of the second ring filter element may be formed with a fold expansion. In other words, in the region of the engagement of the engagement element in the inner filter medium body, at least one fold of its folded bellows may be provided with a fold expansion. This provides space for the engagement of an engagement element which is wider in circumferential direction. In addition, the locally present fold expansion effects a defined angular position of the second ring filter element relative to the engagement element. A fold angle and/or a fold spacing (spacing of radially outer fold edges measured in circumferential direction) may be larger in the region of the fold expansion at the outer wall surface of the inner ring filter element than that of a plurality of folds of the folded bellows, for example all folds-aside from the region of the fold expansion - may have the same fold angle or fold spacing.

The first and/or the second ring filter element may include at least one end disc which seal-tightly delimits the respective filter medium body in axial direction. In addition, the end discs may seal the two ring filter elements relative to each other and/or relative to the filter housing. At an axial end, the end disc of at least one of the ring filter elements may be closed, for example, the two end discs at one axial end may be closed. At the other axial end, both end discs are typically open (i.e., provided with a central opening). The end discs may be cast or glued to the filter medium bodies. The end discs, for example, may be formed of polyurethane, for example polyurethane foam.

The counter engagement element may be formed by a cutout in the end disc of the first and/or second ring filter element. Inasmuch as a fold expansion is provided, the cutout in the end disc may be aligned with the fold expansion. The cutout in the end disc simplifies the arrangement of the respective ring filter element at the engagement element.

The scope of the present invention also encompasses a filter device, including a filter housing with at least one fluid inlet and at least one fluid outlet and further including an above-described ring filter element assembly according to the invention which is arranged in the filter housing and separates the fluid inlet from the fluid outlet. The advantages of the ring filter element assembly may be utilized in the filter device.

The filter device may include a central tube which is fastened to the filter housing, for example non-detachably fastened, wherein at the housing-fixed central tube an engagement element is arranged which extends radially inwardly into the counter engagement element of the second ring filter element as well as radially outwardly into the counter engagement element of the first ring filter element. In the interface region, the central tube engages between the two ring filter elements and aligns them relative to each other and for example also relative to the filter housing.

The filter housing may include a first housing positioning device for, for example unequivocal, relative angular positioning of the first ring filter element in relation to the filter housing, wherein the first housing positioning device includes a first housing engagement element which extends radially inwardly and engages a corresponding housing counter engagement element of the first ring filter element. In this way, the outer ring filter element may be aligned relative to the filter housing and fixed. The inner ring filter element is then aligned at least by means of the positioning device acting between the two ring filter elements—indirectly via the outer ring filter element—relative to the filter housing. As a whole, a completely angular positioned arrangement of the ring filter element assembly of the filter housing results in this way. In addition, the first housing engagement element ensures that only first ring filter elements matching with a housing counter engagement element may be employed.

When the filter medium body of the first ring filter element includes a folded bellows, the first housing engagement element may engage an intermediate space between two neighboring folds of the folded bellows at the outer wall surface of the filter medium body of the first ring filter element. Thus, the intermediate space of the neighboring folds forms the housing counter engagement element. This reduces the expenditure for providing the housing counter engagement element at the first filter medium body. For example, the housing counter engagement element of the first ring filter element may be formed by a fold expansion. In other words, in the region of the engagement of the first housing engagement element in the outer filter medium body, at least one fold of its folded bellows is provided with a fold expansion. This provides space for the engagement of a housing engagement element which is wider in circumferential direction. In addition, the locally present fold expansion effects a defined angular position of the first ring filter element relative to the first housing engagement element. A fold angle and/or a fold spacing (spacing of radially outer fold edges measured in circumferential direction) may be larger in the region of the fold expansion at the outer wall surface of the outer ring filter element than that of a plurality of folds of the folded bellows, for example all folds-aside from the region of the fold expansion-may have the same fold angle or fold spacing.

When at least one fold of the folded bellows of the first ring filter element at the inner wall surface protrudes radially inwardly farther than folds of the folded bellows adjoining in circumferential direction and the protruding fold forms at least partially also the engagement element and engages the counter engagement element of the second ring filter element, the first housing engagement element may engage the fold protruding farther radially inwardly. For example, the first housing engagement element extends radially inwardly into the counter engagement element of the second ring filter element. The first housing engagement element defines then the angular position of both ring filter elements in that it engages their respective housing counter engagement element or counter engagement element. In this context, the engagement element of the first ring filter element engages in addition the counter engagement element of the second ring filter element. The counter engagement element of the second ring filter element is thus engaged by the engagement element of the first ring filter element as well as by the first housing engagement element.

The filter housing may include a second housing positioning device for, for example unequivocal, relative angular positioning of the second ring filter element in relation to the filter housing, wherein the second housing positioning device includes a second housing engagement element that extends radially outwardly and engages a corresponding housing counter engagement element of the second ring filter element. In this way, the inner ring filter element may be aligned relative to the filter housing and fixed. The outer ring filter element is then aligned at least by means of the positioning device acting between the two ring filter elements—indirectly by means of the inner ring filter element—relative to the filter housing. As a whole, a complete angular position arrangement of the ring filter element assembly in the filter housing is provided in this way. In addition, the second housing engagement element ensures that only second ring filter elements matching with a housing counter engagement element may be used.

The filter device may include a support tube which is fastened to the filter housing, for example non-detachably fastened, which engages the interior of the filter medium body of the second ring filter element, wherein the second housing engagement element is arranged at the support tube, for example is one piece together with the support tube. The support tube supports, on the one hand, the filter medium body of the inner ring filter element. On the other hand, the support tube effects the defined rotational alignment of the inner ring filter element relative to the filter housing. For this purpose, the support tube may be fastened to the filter housing in a defined angular position. The support tube is in principle arranged detachably in the interior of the second ring filter element in order to enable an exchange of the ring filter element assembly, for example of the second ring filter element.

When the filter medium body of the second ring filter element includes a folded bellows, the second housing engagement element may engage an intermediate space between two neighboring folds of the folded bellows at the inner wall surface of the filter medium body of the second ring filter element. Thus, the intermediate space of the neighboring folds forms the housing counter engagement element. This reduces the expenditure for providing the housing counter engagement element at the second filter medium body. For example, the housing counter engagement element of the second ring filter element may be formed by a fold expansion. In other words, in the region of the engagement of the second housing engagement element in the inner filter medium body, at least one fold of its folded bellows is provided with a fold expansion. This provides space for the engagement of a counter engagement element which is wider in circumferential direction. In addition, the locally present fold expansion effects a defined angular position of the second ring filter element relative to the second housing engagement element. A fold angle and/or a fold spacing (spacing of radially inner fold edges measured in circumferential direction) may be larger in the region of the fold expansion at the inner wall surface of the inner ring filter element than that of a plurality of folds of the folded bellows; for example all folds—aside from the region of the fold expansion—may have the same fold angle or fold spacing.

The filter housing may include an axial projection which engages an end face cutout of a central tube, at which central tube the engagement element is arranged. In this way, it may be achieved that only matching central tubes may be used. When the central tube is fixedly connected to one of the ring filter elements, for example, the outer ring filter element, the use of a suitable ring filter element is ensured at the same time. In addition, the engagement of the axial projection in the cutout effects that the central tube is aligned in a defined angular position at the filter housing. By means of the central tube and its engagement element, the two ring filter elements are also aligned in a defined angular position at the filter housing.

The invention concerns also the use of an above-described filter device according to the invention as a cathode air filter in a fuel cell.

The scope of the present invention encompasses also a fuel cell with an anode and a cathode between which an electrolyte is arranged and including an above-described filter device according to the invention through which air may be guided to the cathode.

In fuel cells, a two-stage filtration of the air to be supplied to the cathode is often required, for example wherein, in addition to particles, also harmful gases are to be retained. In addition, an angular positioning of the ring filter elements is beneficial for a precise metering of the supplied air by means of a mass air flow sensor in fuel cells for their efficiency. The filter device according to the invention enables this due to its above-described configuration.

Also, the scope of the present invention encompasses a use of a ring filter element, including a filter medium body surrounding an interior and including a counter engagement element at its inner wall surface, as a first ring filter element of an above-described filter device according to the invention, wherein the engagement element of the positioning device extends radially outwardly into the counter engagement element of the first ring filter element. Due to the engagement of the engagement element in the counter engagement element of the (first) ring filter element, the latter is angularly positioned, for example unequivocally, in relation to the second ring filter element. In other words, the two ring filter elements are angularly positioned relative to each other.

Furthermore, the scope of the present invention encompasses a use of a ring filter element, including a filter medium body surrounding an interior and including a counter engagement element at its outer wall surface, as a second ring filter element of an above-described filter device according to the invention, wherein the engagement element of the positioning device extends radially inwardly into the counter engagement element of the second ring filter element. Due to the engagement of the engagement element in the counter engagement element of the (second) ring filter element, the latter is angularly positioned, for example unequivocally, in relation to the first ring filter element. In other words, the two ring filter elements are angularly positioned relative to each other.

The scope of the present invention finally also encompasses a ring filter element for an above-described filter device according to the invention. The ring filter element includes a filter medium body surrounding an interior, wherein the filter medium body includes a folded bellows which is provided at an inner wall surface with a fold expansion. The folded bellows or the filter medium body may be formed for example by a filter medium folded in a star shape.

When the ring filter element is a first ring filter element for the filter device, the fold expansion forms at least partially also a counter engagement element for engagement of an engagement element of a positioning device for relative angular positioning of the first ring filter element in relation to a second ring filter element.

When the ring filter element is a second ring filter element for the filter device, the fold expansion forms at least partially also a housing counter engagement element for engagement of a housing engagement element of a housing positioning device for relative angular positioning of the ring filter element in relation to the filter housing.

The ring filter element may include at least one open end disc which seal-tightly delimits the filter medium body in axial direction, wherein the end disc at an inner circumference includes at least one cutout which is aligned with the fold expansion. The end disc with the cutout adjoins typically the fold expansion. The cutout and the fold expansion form then together the counter engagement element or the housing counter engagement element. At the other axial end, the ring filter element may include a further open or for example a closed end disc which seal-tightly delimits the filter medium body in axial direction.

According to yet another embodiment, the second ring filter element may include an element-fixed central tube arranged at the inner wall surface of the filter medium body of the second ring filter element and fastened indirectly or directly to the filter medium body of the second ring filter element. The central tube of the second ring filter element may include for example at the end face a cutout for engagement of a further housing-fixed axial projection. In this way, a further positioning, for example in relation to the angular position, of the ring filter element assembly in relation to the housing is made possible.

### BRIEF DESCRIPTION OF THE DRAWINGS

Further features and advantages of the invention result from the following detailed description of embodiments of the invention with the aid of the accompanying figures of the drawings showing details according to the invention. The aforementioned and still further explained features may be realized individually by themselves or a plurality combined in any expedient combination in variants of the invention. The features illustrated in the drawing figures are illustrated such that the particularities according to the invention may be made clearly visible.

FIG. 1 shows in a schematic longitudinal section, a first embodiment of a filter device according to the invention with a ring filter element assembly according to the invention comprising an outer ring filter element and an inner ring filter element.

FIG. 2 shows the outer ring filter element of the filter device of FIG. 1 in a schematic longitudinal section.

FIG. 3 shows the inner ring filter element of the filter device of FIG. 1 in a schematic longitudinal section.

FIG. 4 shows a schematic cross section taken from section line 4-4) through the filter device of FIG. 1.

FIG. 5 shows an enlarged detail of FIG. 4.

FIG. 6 shows an enlarged detail 6 of FIG. 1.

FIG. 7 shows a second embodiment of a filter device according to the invention, with a ring filter element assembly comprising an outer filter element and an inner ring filter element, in a schematic cross section.

FIG. 8a shows the filter device of FIG. 7 in a schematic partially sectioned cross section view taken along the section line 8a-8a in FIG. 7.

FIG. 8b shows an enlarged detail of FIG. 8a.

FIG. 9 shows a housing bottom part of the filter device of FIG. 7 in a schematic perspective view.

FIG. 10 shows the outer ring filter element of the filter device of FIG. 7 in a schematic cross section.

FIG. 11 shows the inner ring filter element of the filter device of FIG. 7 in a schematic perspective view.

FIG. 12 shows a second ring filter element for a filter device similar to that of FIG. 1 in a schematic longitudinal section, wherein a counter engagement element is formed in the region of an open end disc.

FIG. 13 shows a third embodiment of a filter device according to the invention, with a ring filter element assembly according to the invention, comprising an outer ring filter element and an inner ring filter element, in a schematic cross section which extends in a stepped manner so that a positioning device between the ring filter elements and a housing positioning device at the outer ring filter element may be seen even though they are arranged at different axial ends.

FIG. 14 shows a detail of the filter device of FIG. 13 in the region of the housing positioning device in a schematic longitudinal section.

FIG. 15 shows a detail of the outer ring filter element of the filter device of FIG. 13 in a schematic longitudinal section.

FIG. 16 shows a fourth embodiment of a filter device according to the invention with a ring filter element assembly according to the invention, comprising an outer ring filter element and an inner ring filter element, in a schematic cross section.

FIG. 17 shows an enlarged detail of FIG. 16.

FIG. 18 shows a detail of the filter device of FIG. 16 in a schematic longitudinal section.

FIG. 19 shows a first ring filter element of the filter device of FIG. 16 in a schematic longitudinal section.

FIG. 20 shows a fifth embodiment of a filter device according to the invention with a ring filter element assembly according to the invention, comprising an outer ring filter element and an inner ring filter element, in a schematic cross section which extends in a stepped manner so that a positioning device between the ring filter elements and a first housing positioning device at the outer ring filter element as well as a second housing positioning device at the inner ring filter element may be seen even though they are arranged at different axial ends.

FIG. 21 shows an enlarged detail of FIG. 20.

FIG. 22 shows a detail of the filter device of FIG. 20 in a schematic longitudinal section in the region of the second housing positioning device at an open end disc of the inner ring filter element.

FIG. 23a shows a detail of the filter device of FIG. 20 in a schematic longitudinal section in the region of closed end discs with the positioning device between the two ring filter elements and the first housing positioning device.

FIG. 23b shows a longitudinal section of an alternative to FIG. 23a, wherein the second ring filter element comprises an element-fixed central tube comprising an end face cutout for engagement of a further housing-fixed axial projection.

FIG. 24 shows the second ring filter element of the filter device of FIG. 20 in a schematic perspective view.

FIG. 25 shows a second ring filter element according to the invention for a filter device according to the invention in a schematic perspective view.

FIG. 26 shows a sixth embodiment of a filter device according to the invention with a ring filter element assembly according to the invention, comprising an outer ring filter element and an inner ring filter element, in a schematic longitudinal section.

FIG. 27 shows the filter device of FIG. 26 in a schematic longitudinal section with a section plane rotated by 90° compared to FIG. 26.

FIG. 28 shows a seventh embodiment of a filter device according to the invention with a ring filter element assembly according to the invention, comprising an outer ring filter element and an inner ring filter element, in a schematic longitudinal section.

FIG. 29 shows the filter device of FIG. 28 in a schematic longitudinal section with a section plane rotated by 90° compared to FIG. 28.

FIG. 30 shows a schematic illustration of a use according to the invention of the filter device according to the invention as cathode air filter in a fuel cell.

### DETAILED DESCRIPTION

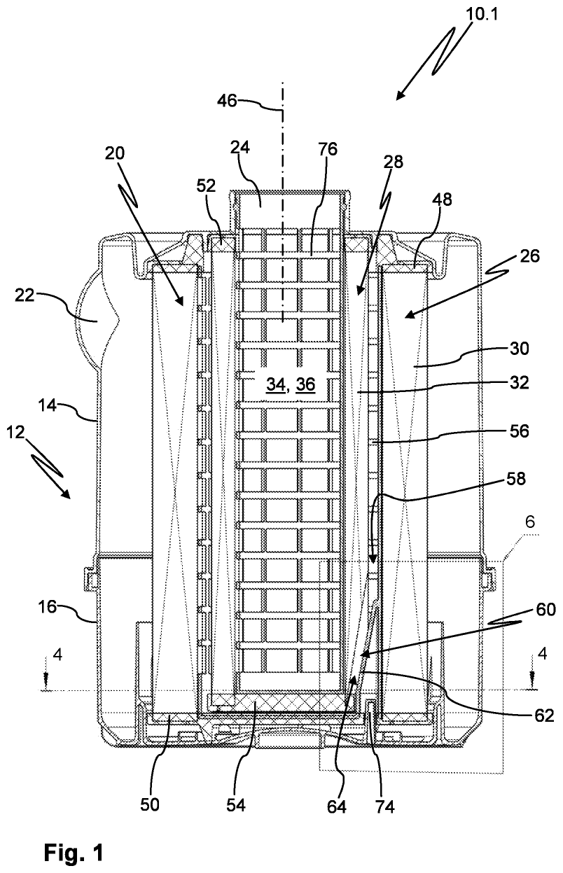

FIG. 1 shows a filter device 10.1, here in the form of an air filter. The filter housing 12 of the filter device 10.1 comprises a housing top part 14 and a housing bottom part 16 which are releasably connected to each other. A ring filter element assembly 20 is received in the filter housing 12. The ring filter element assembly 20 separates a fluid inlet 22 for unfiltered air from a fluid outlet 24 for filtered air. The fluid inlet 22 and the fluid outlet 24 are formed here in an exemplary fashion at the housing top part 14.

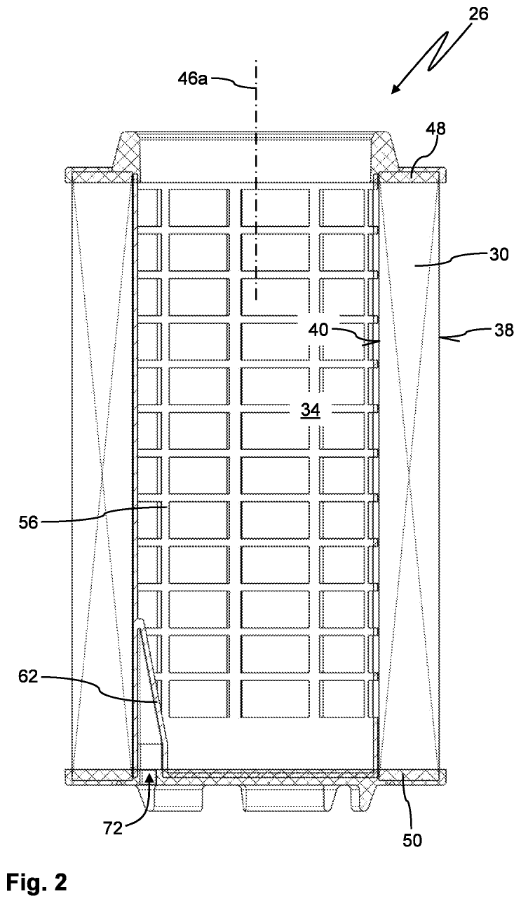

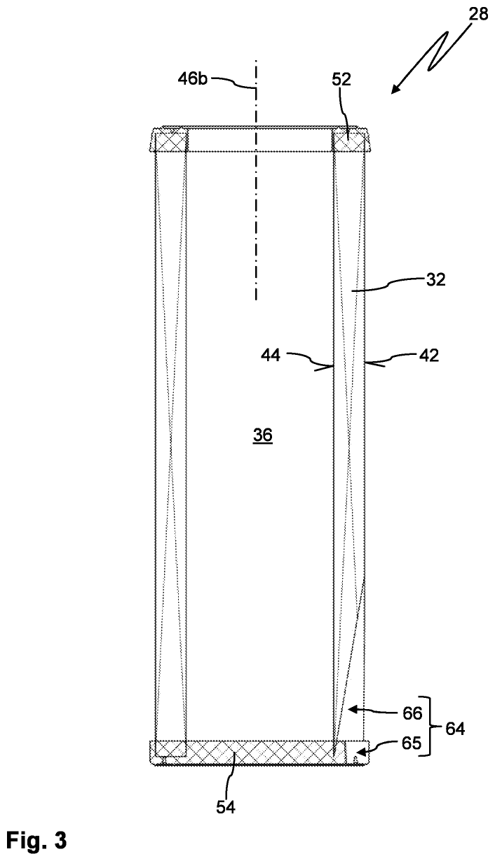

The ring filter element assembly 20 comprises a first or outer ring filter element 26, see also FIG. 2, and a second or inner ring filter element 28, see also FIG. 3, which may be flowed through serially in radial direction from the exterior to the interior. The two ring filter elements 26, 28 each comprise a filter medium body 30 or 32 which encloses a respective interior 34 or 36. The filter medium bodies 30, 32 are embodied here hollow cylindrically with a circular ring-shaped cross section, respectively. An outer wall surface of the first filter medium body 30 is identified by the reference character 38, an inner wall surface of the first filter medium body 30 is identified by the reference character 40. An outer wall surface of the second filter medium body 32 is identified by the reference character 42, an inner wall surface of the second filter medium body 32 is identified by reference character 44.

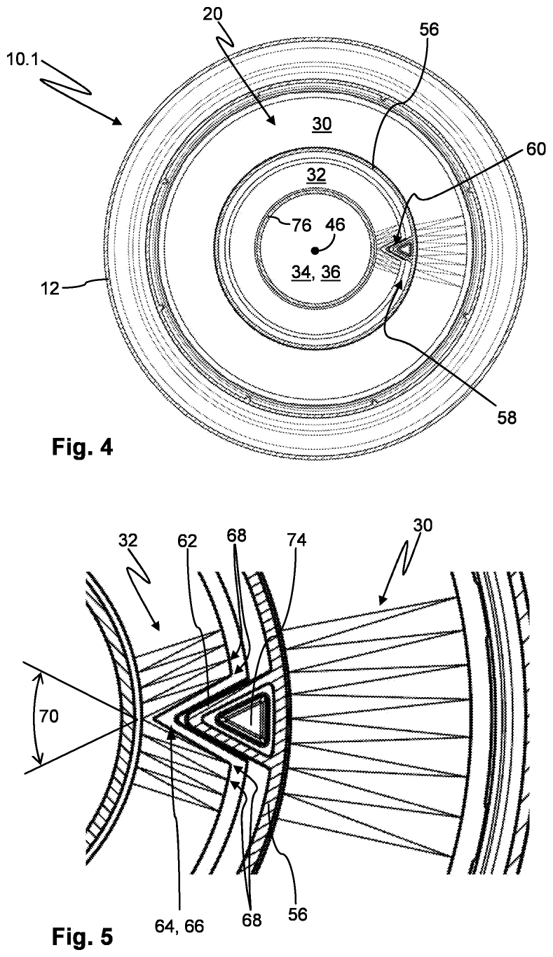

In the mounted state, the two ring filter elements 26, 28 are arranged coaxially to each other, compare FIG. 1 and FIG. 4. Longitudinal axes 46a, 46b of the filter medium bodies 30, 32 extending through the respective interiors 34, 36 coincide in a common longitudinal axis 46.

The two filter medium bodies 30, 32 are here formed as a folded bellows, respectively, which is obtained by a star-shaped folding of a flat filter medium. In FIG. 4, some of the respective folds are illustrated. The filter medium, for example of the second ring filter element 28 downstream in flow direction, may contain an adsorbent, for example, active carbon, in order to remove harmful gases from the air flow to be filtered.

Axial end faces of the two filter medium bodies 30, 32 are sealed by an end disc 48, 50, 52, 54, respectively. Presently, closed end discs 50, 54 are provided at one end, respectively. At the other end, open end discs 48, 52 are provided, respectively, in order to enable, on the one hand, the insertion of the inner ring filter element 28 into the outer ring filter element 26 and, on the other hand, to enable the exit of filtered air through the fluid outlet 24. In the mounted state, the open end discs 48, 52 here sealingly contact the housing top part 14, respectively.

At the inner circumference, the first ring filter element 26 comprises a central tube 56 which at its axial ends is embedded in the two end discs 48, 50. The central tube 56 is thus an integral component of the first ring filter element 26.

As already mentioned above, the second ring filter element 28 (here across the major portion of its length extension) is received in the first ring filter element 26, compare FIG. 1. In other words, the first filter medium body 30 surrounds the second filter medium body 32, compare also FIG. 4. Between the inner wall surface 40 of the first filter medium body 30 and the outer wall surface 42 of the second filter medium body 32, an annular gap is formed presently. The region between the inner wall surface 40 of the first filter medium body 30 and the outer wall surface 42 of the second filter medium body 32 is referred to in the context of the present invention also as an interface region 58.

A positioning device 60 is acting between the first and the second ring filter elements 26, 28 and holds the two ring filter elements 26, 28 relative to each other in a defined angular position (rotational position) in relation to the longitudinal axis 46, compare FIGS. 1 and 4. The positioning device 60 comprises an engagement element 62 which is arranged in the interface region 58 between the two ring filter elements 26, 28, compare also FIG. 5.

In this embodiment, the engagement element 62 is a radially inwardly pointing projection at the central tube 56 of the outer (first) ring filter element 26, compare also FIG. 2. The engagement element 62 and the central tube 56 are here embodied together as one piece as a common injection molded part.

The inner (second) ring filter element 28 comprises at least one corresponding counter engagement element 64. The counter engagement element 64 is formed here by a cutout 65 in the closed end disc 54 (compare for example FIG. 3) as well as a fold expansion 66 at the outer wall surface 42 of the filter medium body 32 folded in a star shape (compare for example FIG. 5). The cutout 65 and the fold expansion 66 are aligned with each other, compare for example FIG. 3.

In the region of the fold expansion 66, a fold spacing measured in circumferential direction between radially outer fold edges 68 of the second filter medium body 32 is enlarged in comparison to the fold spacing of adjoining outer fold edges 68. Here, the fold expansion 66 is limited to a single outwardly open fold. Due to the fold expansion 66, a fold angle 70 is also enlarged compared to the adjoining folds. Presently, the fold expansion 66 does not extend across the entire axial length of the second filter medium body 32 but is limited to less than one third of its entire length.

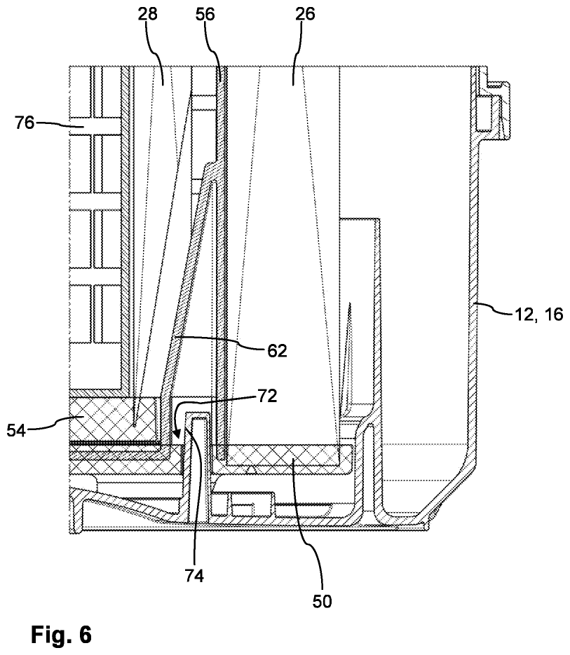

The engagement element 62 extends into the counter engagement element 64. For example, the engagement element 62 engages in radial direction between the two spread-apart outer fold edges 68, compare for example FIG. 5. In addition, the engagement element 62 engages in radial direction the cutout 65 of the end disc 54, compare for example FIG. 6, which shows detail 6 of FIG. 1.

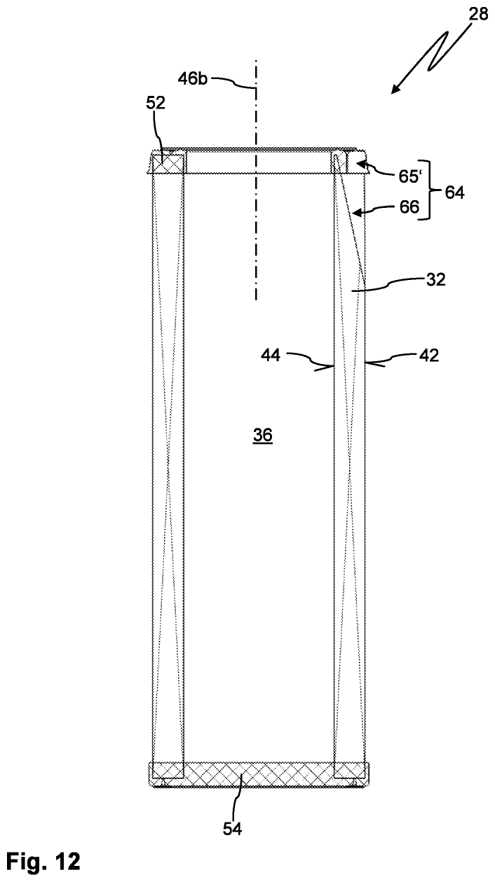

In the filter device 10.1, the positioning device 60 is arranged in the region of the closed end discs 50, 54. It is understood that in a modified embodiment the positioning device 60 may also be arranged in a corresponding manner in the region of the open end discs 48, 52, compare FIG. 12 which shows a corresponding second ring filter element 28. Here, a cutout 65′ of the counter engagement element 64 is formed in the open end disc 52. A fold expansion 66 adjoins below the end disc 52 in alignment with the cutout 65′ and extends across less than one third of the axial length of the filter medium body 32.

In the filter device 10.1, the engagement element 62 at the end face (in the region of the end disc 50) comprises a cutout 72, compare FIGS. 2 and 6. The otherwise closed end disc 50 is also perforated in the region of the cutout 72. The engagement element 62 is, however fluid-tightly closed and embedded seal-tightly in the end disc 50 so that the first ring filter element 26 remains sealed at the bottom end.

A housing-fixed axial projection 74, which here is formed as one piece together with the housing bottom part 16, engages the cutout 72 of the engagement element 62, compare FIGS. 1 and 6. In other words, the axial projection 74 extends through the end disc 50 into the hollow engagement element 62.

Due to the engagement of the axial projection 74 in the cutout 72 of the engagement element 62, a defined angular position of the first ring filter element 26 in relation to the filter housing 12 is created. By means of the engagement of the engagement element 62 in the counter engagement element 64 of the second ring filter element 28, the second ring filter element 28 (indirectly through the first ring filter element 26) is thus also angularly positioned relative to the filter housing 12. The engagement element 62 which is fixedly connected to the first ring filter element 26 effects thus an angular positioning of the two ring filter elements 26, 28 of the ring filter element assembly 20 relative to each other as well as of the ring filter element assembly 20 as a whole in relation to the filter housing 12.

The support tube 76 arrangeable fixedly at the housing, for example, lockable at the housing top part 14, may radially inwardly support the second ring filter element 28 at its inner wall surface 44, compare FIG. 1.

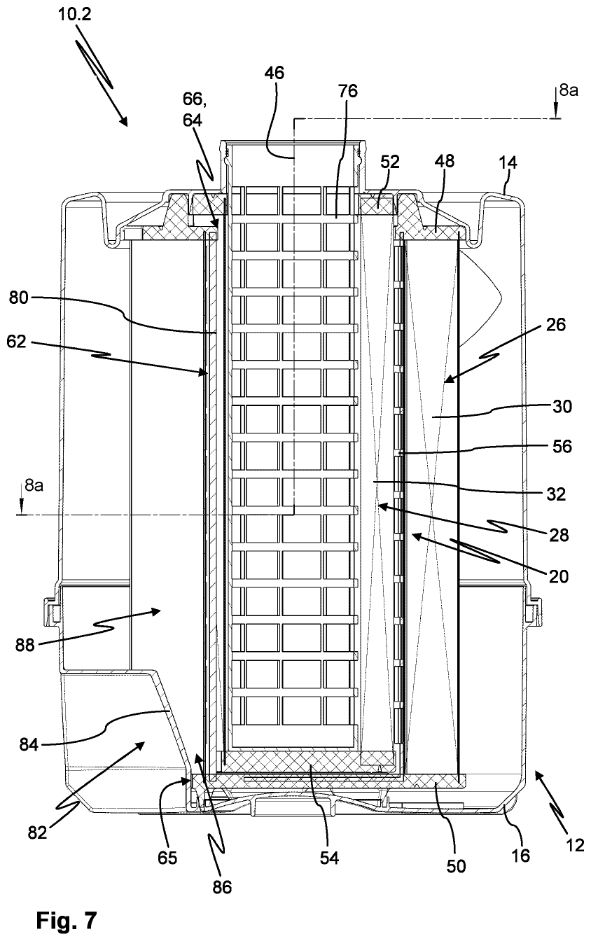

FIG. 7 shows a second filter device 10.2. The filter device 10.2 of FIG. 7 corresponds in many aspects to the above described filter device 10.1 shown in FIGS. 1 through 6. In the following, primarily the differences will be explained. In other respects, reference is being had to the preceding description.

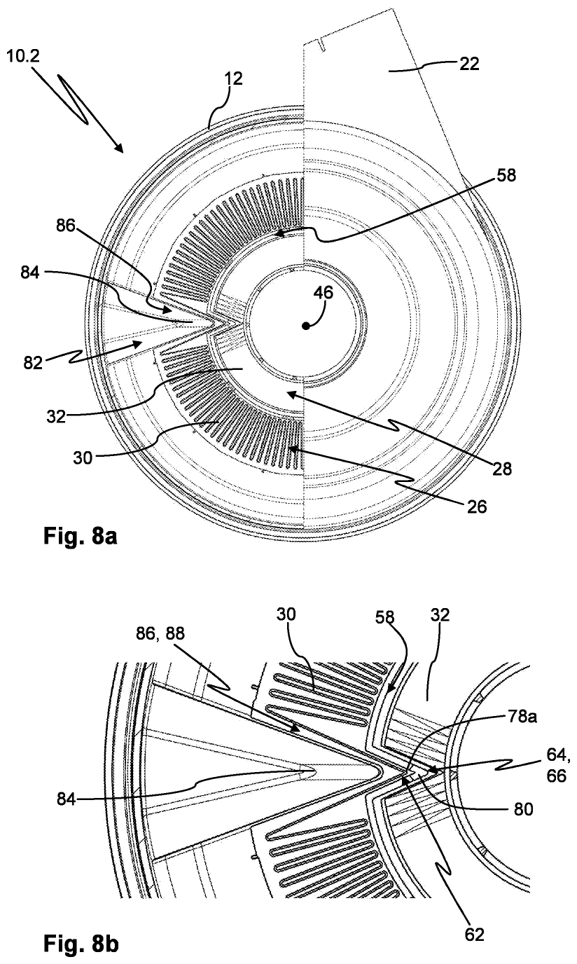

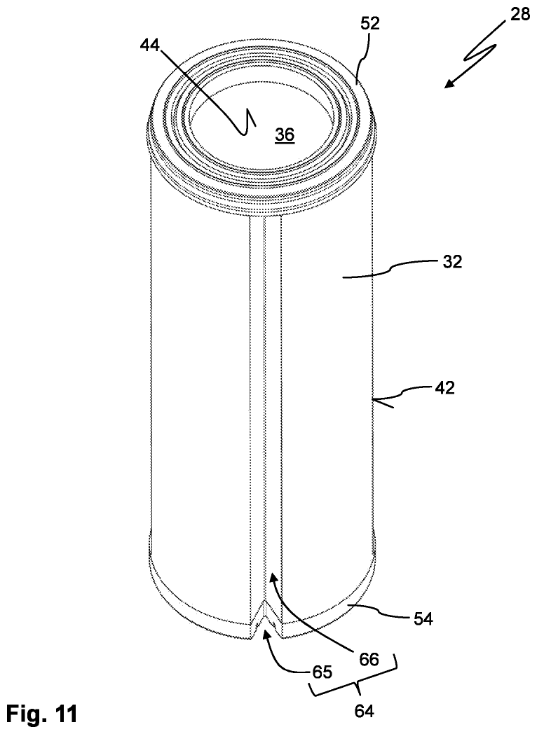

The filter device 10.2 also comprises a ring filter element assembly 20 with two ring filter elements 26, 28 coaxially arranged in relation to a common longitudinal axis 46 in a filter housing 12, compare also FIG. 8a. Here also, filter medium bodies 30, 32 of the two ring filter elements 26, 28 are formed by filter bellows folded in a star shape. Likewise, as described above, the second (inner) ring filter element 28 comprises a counter engagement element 64 which comprises a cutout 65 in a closed end disc 54 as well as a fold expansion 66 at the outer wall surface 42, compare also FIG. 11. Here, the fold expansion 66 extends across the entire axial length of the second filter medium body 32 all the way to an open end disc 52.

At the inner wall surface 40 of the first (outer) ring filter element 26, a radially inner fold edge 78a projects into the interior 34 past the adjoining radially inner fold edges 78b, compare FIG. 10. Presently, all inner fold edges 78b have the same spacing from the longitudinal axis 46a while the spacing of the projecting fold edge 78a from the longitudinal axis 46a is smaller.

A central tube 56 fixedly connected to the first ring filter element 26 comprises a projection 80 in radially inward direction in the region of the radially inwardly projecting fold. The central tube 56 follows thus the contour of the inner wall surface 40 of the first filter medium body 30.

The protruding fold edge 78a and the projection 80 form together an engagement element 62 of the first ring filter element 26. Here, the engagement element 62 extends across the entire axial length of the first filter medium body 30.

In the mounted state, the engagement element 62 of the first ring filter element 26 engages the counter engagement element 64 of the second ring filter element 28, compare FIG. 7 and FIG. 8b. The projection 80 of the central tube 56 as well as the protruding fold edge 78a of the filter medium body 30 project radially inwardly into the fold expansion 66 of the second filter medium body 32. In this way, the two ring filter elements 26, 28 are aligned in a defined angular position relative to each other.

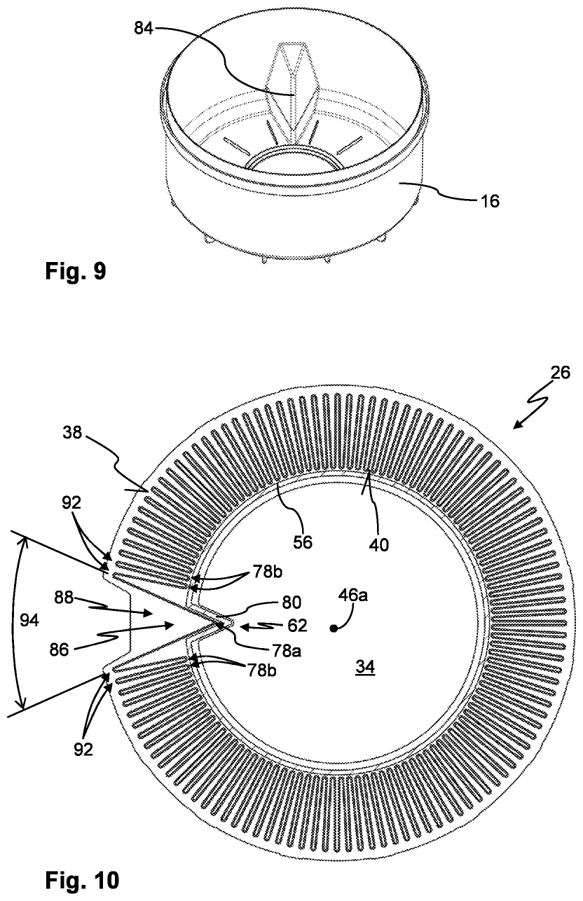

In order to align the ring filter element assembly 20 in relation to the filter housing 12 in its angular position in relation to the longitudinal axis 46, a (first) housing positioning device 82 is provided in the filter device 10.2, compare FIGS. 7 and 8a. The housing positioning device 82 comprises a first housing engagement element 84. The housing engagement element 84 is here in the form of a wedge-shaped rib which in an exemplary fashion is formed as one piece together with the housing bottom part 16, compare FIGS. 7 and 8a/8b as well as for example FIG. 9. Presently, the housing engagement element 84 tapers upwardly and projects less far radially inwardly in upward direction. In axial direction, the height of the housing engagement element 84 is limited to less than one fourth of the length of the first filter medium body 30.

The housing engagement element 84 engages a (first) housing counter engagement element 86 at the first ring filter element 26. The first housing counter engagement element 86 comprises here a fold expansion 88 at the outer wall surface 38 of the first filter medium body 30 as well as a cutout 90 in its closed end disc 50, compare for example FIGS. 7, 8a/8b, 10 and 15.

In the region of the fold expansion 88, a fold spacing measured in circumferential direction between radially outer fold edges 92 of the first filter medium body 30 is enlarged in comparison to the fold spacing of adjoining outer fold edges 92. Here, the fold expansion 88 is limited to a single outwardly open fold. Due to the fold expansion 88, also a fold angle 94 is enlarged in comparison to the adjoining folds. Presently, the fold expansion 88 extends across the entire axial length of the first filter medium body 30.

The radially inwardly protruding fold edge 78a of the first ring filter element 26 may project so far inwardly that also the housing engagement element 84 may extend into the counter engagement element 64 of the second ring filter element 28, compare FIGS. 7 and 8b. For example, the housing engagement element 84 may extend radially inwardly into the cutout 65 of the end disc 54 and/or into the fold expansion 66.

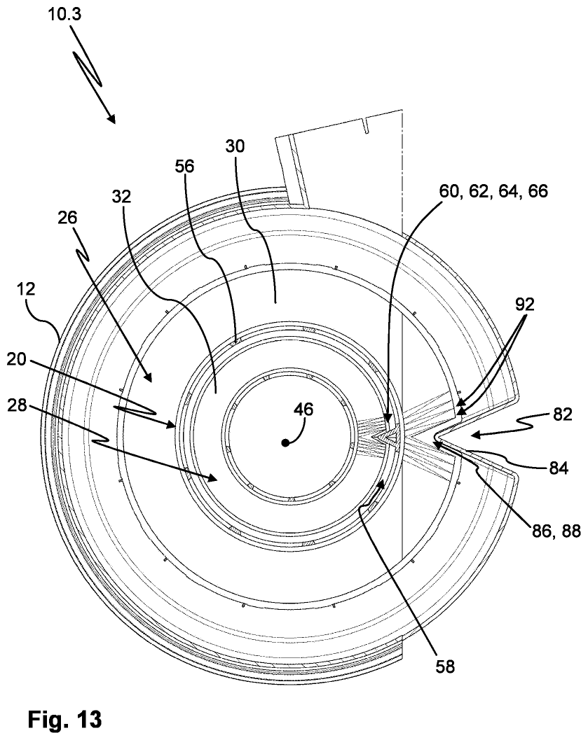

FIG. 13 shows a third filter device 10.3. The filter device 10.3 of FIG. 13 corresponds in many aspects to the above described filter device 10.1 shown in FIGS. 1 to 6. In the following, primarily the differences will be explained. In other respects, reference is being had to the preceding description.

The filter device 10.3 also comprises a ring filter element assembly 20 with two ring filter elements 26, 28 arranged coaxially to a common longitudinal axis 46 in a filter housing 12. Here also, filter medium bodies 30, 32 of the two ring filter elements 26, 28 are formed by filter bellows folded in a star shape. As in the filter device 10.1, in the filter device 10.3 a positioning device 60 between the two ring filter elements 26, 28 with an engagement element 62 in the form of a radially inwardly pointing projection is formed at a central tube 56 which is fixedly connected to the outer ring filter element 26. The engagement element 62 engages a counter engagement element 64 at the inner ring filter element 28 which here also is formed by a fold expansion 66 at the outer wall surface 42 of the second filter medium body 32 (compare in this regard also FIG. 5). In addition, the counter engagement element 64 may comprise a cutout 65 or 65′ aligned with the fold expansion 66 at the closed end disc 54 or at the open end disc 52 (compare in this regard also FIGS. 3 and 12).

In the filter device 10.3, a first housing positioning device 82 is additionally provided (similar to the filter device 10.2 of FIG. 7) which aligns the first ring filter element 26 relative to the filter housing 12 in a defined angular position in relation to the longitudinal axis 46.

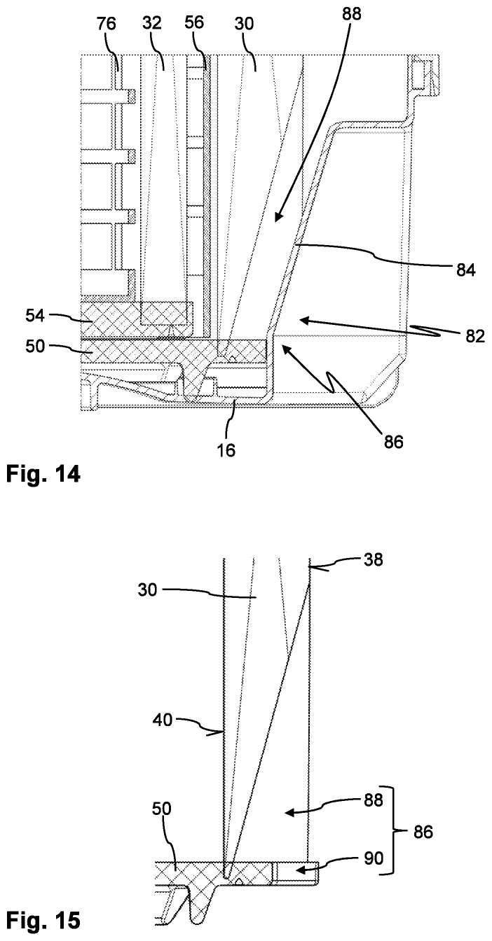

The housing positioning device 82 comprises a first housing engagement element 84. The housing engagement element 84 is formed here also in the form of a wedge-shaped rib which, for example, may be one piece together with the housing bottom part 16, compare in this regard also FIG. 9 as well as FIG. 14. Here, the housing engagement element 84 also tapers upwardly and projects less far radially inwardly in upward direction. In axial direction, the height of the housing engagement element 84 is limited to less than one fourth of the length of the first filter medium body 30.

The housing engagement element 84 engages a (first) housing counter engagement element 86 at the first ring filter element 26. The first housing counter engagement element 86 comprises here also a fold expansion 88 at the outer wall surface 38 of the first filter medium body 30 as well as a cutout 90 in its closed end disc 50, compare also FIG. 15. Here, the fold expansion 88 does not extend across the entire axial length of the first filter medium body 30 but is limited to a less than one third of its entire length.

In the region of the fold expansion 88, a fold spacing measured in circumferential direction between radially outer fold edges 92 of the first filter medium body 30 is enlarged in comparison to the fold spacing of adjoining outer fold edges 92, compare FIG. 13. Here, the fold expansion 88 is limited to a single outwardly open fold. Due to the fold expansion 88, a fold angle 94 in relation to the adjoining folds is also enlarged, compare in this regard also FIG. 10.

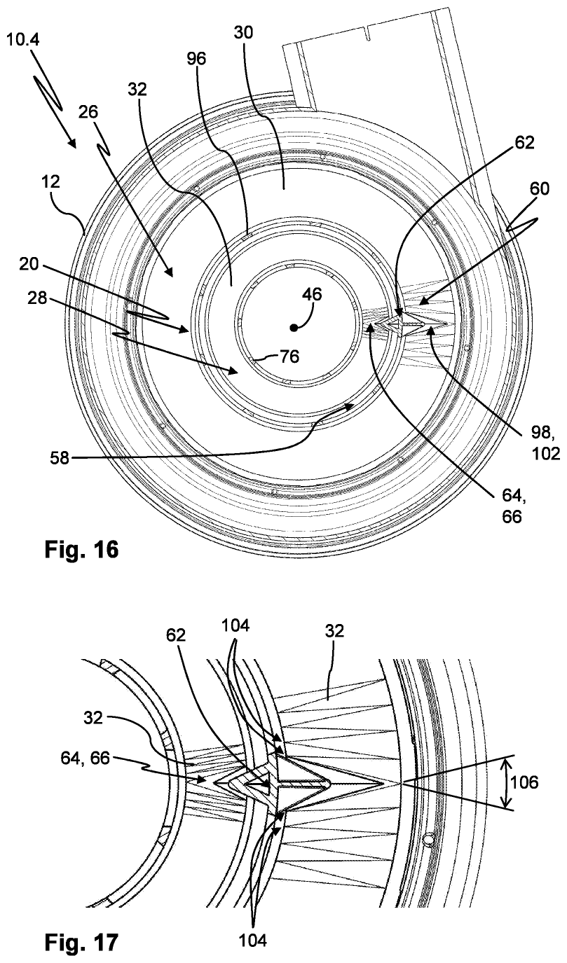

FIG. 16 shows a fourth filter device 10.4. The filter device 10.4 of FIG. 16 corresponds in many aspects to the above described filter device 10.1 shown in FIGS. 1 to 6. In the following, primarily the differences will be explained. In other respects, reference is being had to the preceding description.

The filter device 10.4 also comprises a ring filter element assembly 20 with two ring filter elements 26, 28 arranged coaxially to a common longitudinal axis 46 in a filter housing 12. Here also, filter medium bodies 30, 32 of the two ring filter elements 26, 28 are formed by filter bellows folded in a star shape. Also, as described above, the second (inner) ring filter element 28 comprises a counter engagement element 64 which comprises a cutout 65′ in an open end disc 52 as well as the fold expansion 66 at the outer wall surface 42, compare in this regard also FIG. 12.

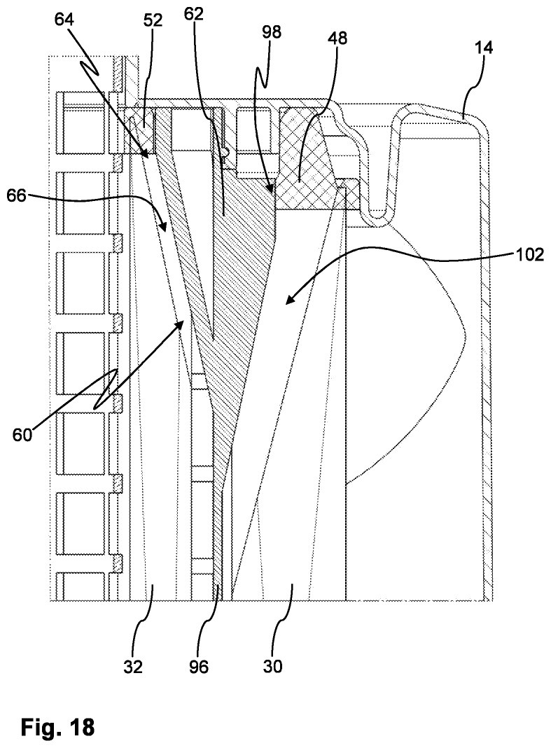

In the filter device 10.4, an engagement element 62 of a positioning device 60 is formed at a central tube 96 which is fixedly connected to the filter housing 12, compare also FIG. 18. The central tube 96 may be locked, for example, in a fixed angular position at the housing top part 14. This angular position may be defined by the engagement of a housing-fixed axial projection in an end face cutout at the central tube (not illustrated in detail). For assembly, the two ring filter elements 26, 28 may be pushed onto the central tube 96 and pulled off the central tube 96 for demounting.

The engagement element 62 projects, on the one hand, radially inwardly into the counter engagement element 64 of the second ring filter element 28. In this way, an angular position of the second ring filter element 28 in relation to the longitudinal axis 46 is fixed relative to the filter housing 12. On the other hand, the engagement element 62 projects radially outwardly into a further counter engagement element 98 of the first ring filter element 26. In this way, an angular position of the first ring filter element 26 in relation to the longitudinal axis 46 is fixed relative to the filter housing 12. Since the engagement element 62 of the central tube 96 engages the counter engagement elements 64, 98 of both filter elements 26, 28, the latter are also fixed relative to each other in relation to the longitudinal axis 46 in a defined angular position; this applies even when the central tube should be held rotatably at the filter housing 12.

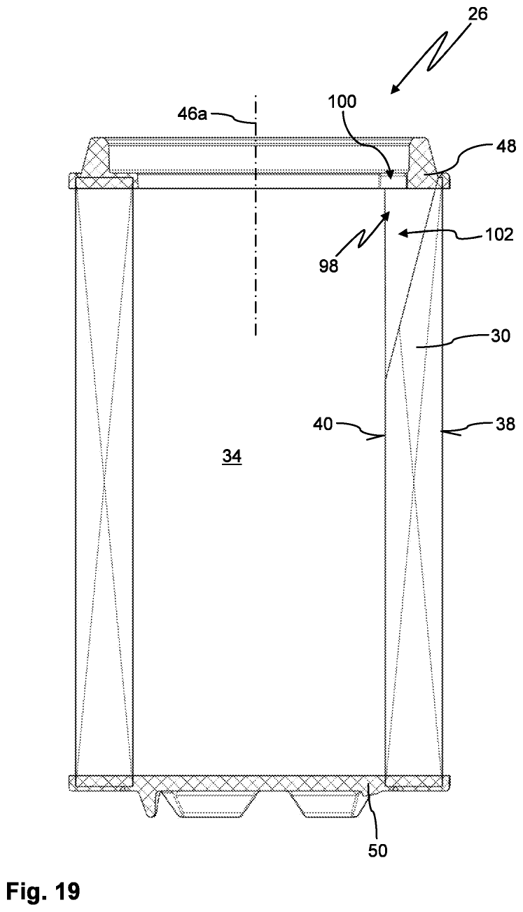

The counter engagement element 98 of the first ring filter element 26 comprises a cutout 100 which is formed here radially inwardly at the open end disc 48, compare also FIG. 19. In addition, the counter engagement element 98 comprises a fold expansion 102, aligned with the cutout 100, at the inner wall surface 40 of the first filter medium body 30. Here, the fold expansion 102 does not extend across the entire axial length of the first filter medium body 30 but is limited to less than one third of its entire length.

In the region of the fold expansion 102, a fold spacing between radially inner fold edges 104 of the first filter medium body 30 measured in circumferential direction is enlarged compared to the fold spacing of adjoining inner fold edges 104, compare for example FIG. 17. Here, the fold expansion 102 is limited to a single inwardly open fold. Compared to the adjoining folds, a fold angle 106 is also enlarged due to the fold expansion 102.

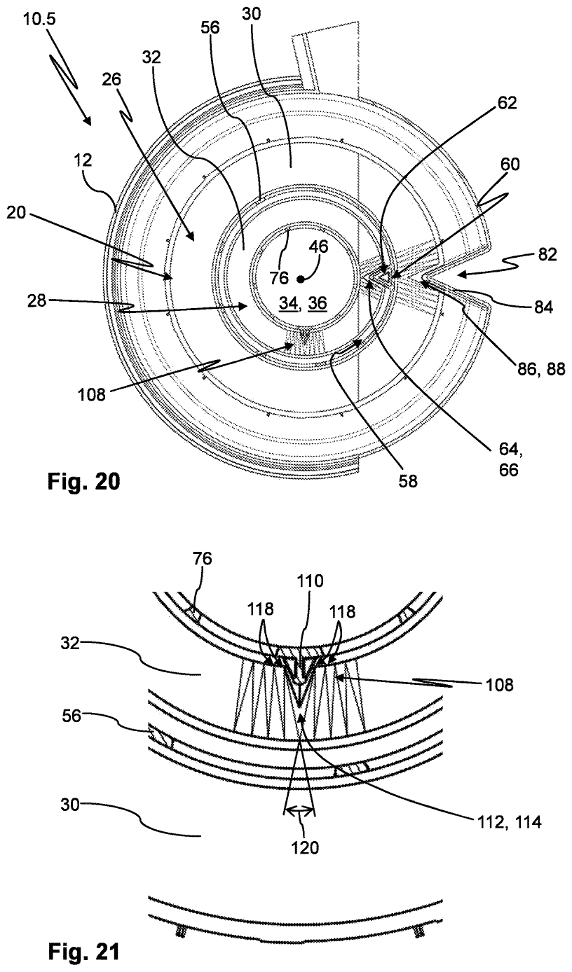

FIG. 20 shows a fifth filter device 10.5. The filter device 10.5 of FIG. 20 corresponds in many aspects to the above described filter device 10.1 which is illustrated in FIGS. 1 to 6. In the following, primarily the differences will be explained; in other respects, reference is being had to the preceding description.

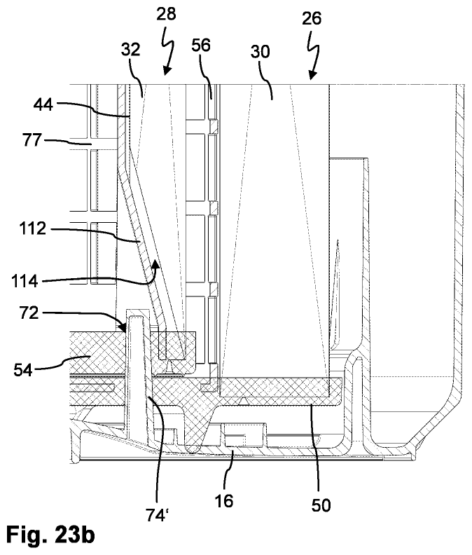

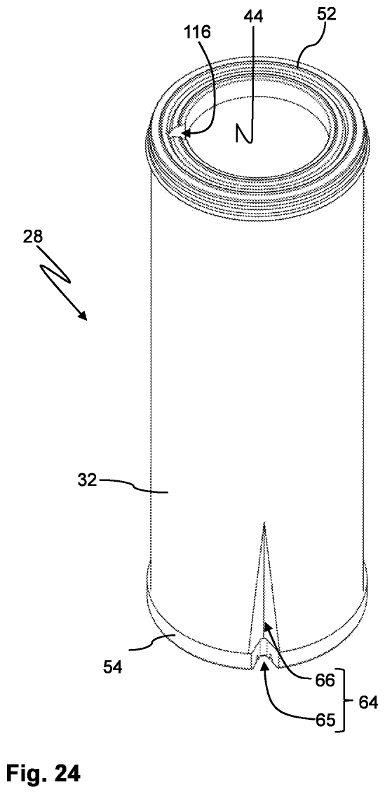

The filter device 10.5 also comprises a ring filter element assembly 20 with two ring filter elements 26, 28 arranged coaxially to a common longitudinal axis 46 in a filter housing 12. Here also, filter medium bodies 30, 32 of the two ring filter elements 26, 28 are formed by filter bellows folded in a star shape. As in the filter device 10.1, at the filter device 10.5 a positioning device 60 between the two ring filter elements 26, 28 is formed by an engagement element 62 in the form of a radially inwardly pointing projection at a central tube 56 which is fixedly connected to the outer ring filter element 26, compare also FIG. 23a. The engagement element 62 engages a counter engagement element 64 at the inner ring filter element 28 which here also is formed by a fold expansion 66 at the outer wall surface 42 of the second filter medium body 32 (compare in this respect also FIG. 5). In addition, the counter engagement element 64 comprises a cutout 65, aligned with the fold expansion 66, at the closed end disc 54, compare FIG. 24.

Similar to the filter device 10.3 of FIG. 13, a first housing positioning device 82 is provided which aligns the first ring filter element 26 relative to the filter housing 12 in a defined angular position in relation to the longitudinal axis 46, compare FIGS. 20 and 23. The housing positioning device 82 comprises a first housing engagement element 84 which here also is in the form of a wedge-shaped rib which, for example, may be one piece together with the housing bottom part 16, compare in this regard also FIG. 9. Here also, the first housing engagement element 84 tapers upwardly and does not project as far radially inwardly in upward direction. In axial direction, the height of the first housing engagement element 84 is limited to less than one fourth of the length of the first filter medium body 30.

The first housing engagement element 84 engages a (first) housing counter engagement element 86 at the first ring filter element 26. The first housing counter engagement element 86 comprises here also a fold expansion 88 at the outer wall surface 38 of the first filter medium body 30 as well as a cutout 90 in its closed end disc 50, compare FIG. 23a and in addition FIG. 15. Here, the fold expansion 88 does not extend across the entire axial length of the first filter medium body 30 but is limited to less than one third of its entire length.

In the region of the fold expansion 88, a fold spacing measured in circumferential direction between radially outer fold edges 92 of the first filter medium body 30 in comparison to the fold spacing of adjoining outer fold edges 92 is enlarged, compare in this regard FIG. 13. Here, the fold expansion 88 is limited to a single outwardly open fold. Due to the fold expansion 88, also a fold angle 94 in relation to the adjoining folds is enlarged, compare in this regard also FIG. 10.

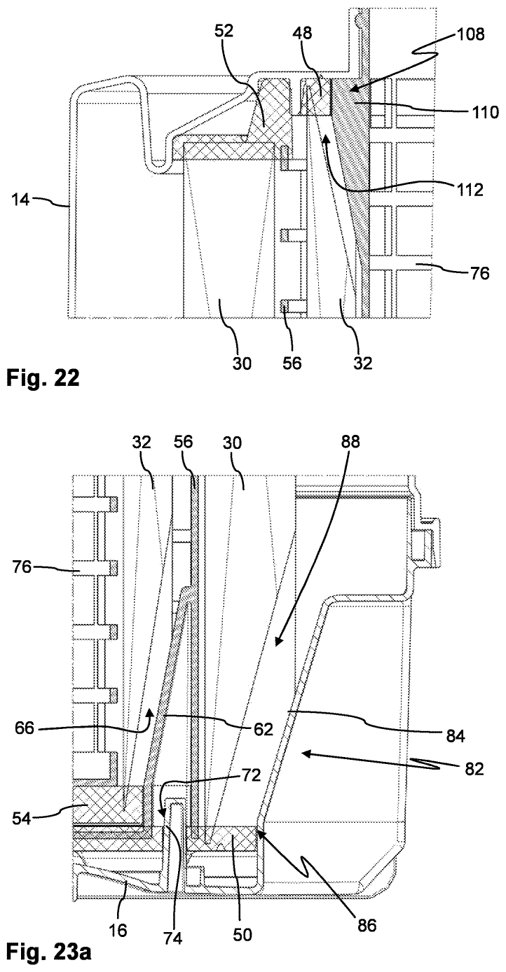

In addition, in the filter device 10.5 a second housing positioning device 108 is provided which aligns the second ring filter element 28 relative to the filter housing 12 in a defined angular position in relation to the longitudinal axis 46, compare FIG. 20. The second housing positioning device 108 comprises a second housing engagement element 110, compare also FIGS. 21 and 22. The second housing engagement element 110 is embodied in the form of a radially outwardly oriented projection at a housing-fixed support tube 76. The support tube 76 may be locked in a defined angular position at the housing top part 14.

The second housing engagement element 110 engages a second housing counter engagement element 112 at the second ring filter element 28. The second housing counter engagement element 112 comprises a fold expansion 114 at the inner wall surface 44 of the second filter medium body 32 (compare for example FIG. 21) as well as a cutout 116 radially inwardly at its open end disc 52, compare also FIG. 24. Here, the fold expansion 114 does not extend across the entire axial length of the first filter medium body 30 but is limited to less than one fourth of its entire length, compare FIG. 22. The counter engagement element 64 may be displaced in circumferential direction in relation to the second housing counter engagement element 112, for example, by 90°, compare FIGS. 20 and 24.

In the region of the fold expansion 114, a fold spacing measured in circumferential direction between radially inner fold edges 118 of the second filter medium body 32 is enlarged compared to the fold spacing of adjoining inner fold edges 118, compare FIG. 21. Here, the fold expansion 114 is limited to a single inwardly open fold. Due to the fold expansion 114, a fold angle 120 in relation to the adjoining folds is also enlarged.

As an alternative to the embodiment of FIG. 23a, in FIG. 23b an embodiment is illustrated in which the second ring filter element 28 comprises an element-fixed central tube 77 which is arranged at the inner wall surface 44 of the filter medium body 32 of the second ring filter element 28 and indirectly or directly is fastened to the filter medium body 32 of the second ring filter element 28. The element-fixed central tube 77 of the second ring filter element 28 comprises at the end face a cutout 72 for engagement of a further housing-fixed axial projection 74′. The cutout 72 of the central tube 77 is part of a housing counter engagement element 112 of the second ring filter element 28 and extends for example radially outwardly in a fold expansion 114 at the inner wall surface 44 of the filter medium body 32 of the second ring filter element 28. The closed end disc 54 of the second ring filter element 28 may comprise a perforation through which the further housing-fixed axial projection 74′ extends in order to engage the end face cutout 72 of the element-fixed central tube 77 of the second ring filter element 28. Furthermore, a closed end disc 50 of the first ring filter element 26 may also comprise a perforation which is aligned with the perforation of the closed end disc 54 of the second filter element 28.

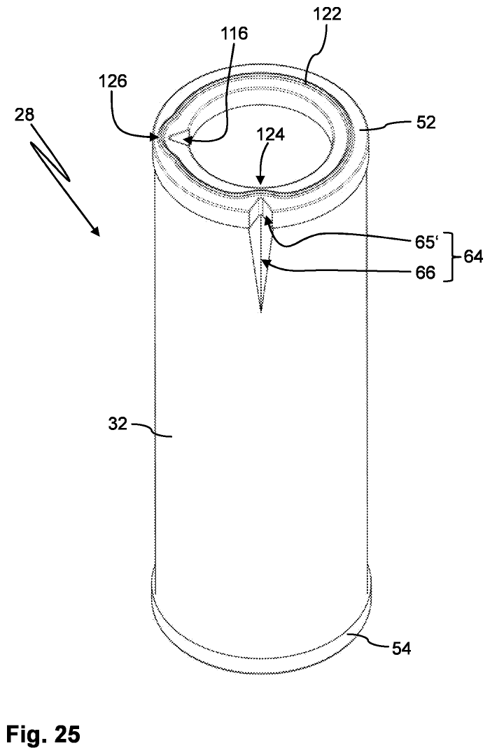

FIG. 25 shows a second ring filter element 28 for a filter device which substantially corresponds to the filter device 10.5 of FIG. 20. The ring filter element 28 also comprises at its inner wall surface 44 a second housing counter engagement element 112 with a fold expansion 114 and a cutout 116 in the open end disc 52. In the ring filter element 28 of FIG. 25, a counter engagement element 64 for a positioning device 60, acting between the two ring filter elements 26, 28, is also provided with a cutout 65′ at the open end disc 52 and an adjoining fold expansion 66, compare in this regard FIG. 12 or FIG. 18 and the respective corresponding description.

The end disc 52 comprises an axially protruding sealing bead 122 for contact at the housing top part 14. In the ring filter element 28 of FIG. 25, the sealing bead 122 in the region of the cutouts 65′ and 116 comprises a depression 124 in radially inward direction or a bulge 126 in radially outward direction. In this regard, the incidentally circular sealing bead 122 deviates in these regions from the circular shape.

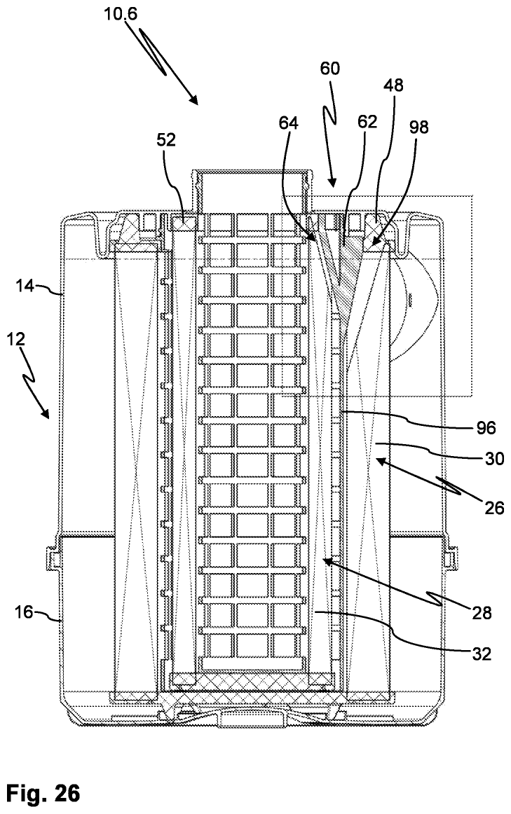

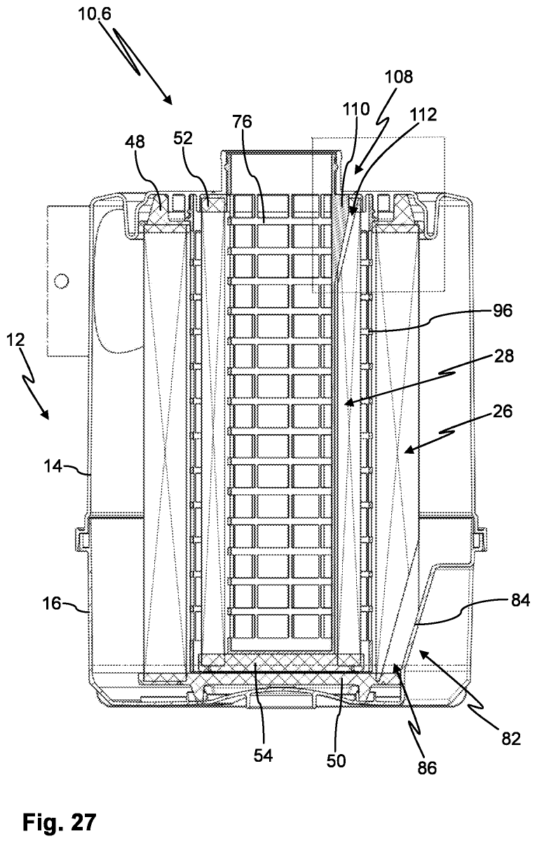

FIGS. 26 and 27 show a sixth filter device 10.6 which in many aspects corresponds to the filter device 10.3 of FIG. 13. In the following, primarily the differences will be explained; in other respects, reference is being had to the preceding description.

In the filter device 10.6, a positioning device 60 acting between the ring filter elements 26, 28 is provided. An engagement element 62 which is formed at a housing-fixed central tube 96 engages radially inwardly and radially outwardly in corresponding counter engagement elements 64, 98 at open end discs 48, 52 of the second and first ring filter elements 28, 26, compare FIG. 26.

In addition, the filter device 10.6 comprises a first housing positioning device 82, compare FIG. 27. As in the filter devices 10.3 and 10.5, a first housing engagement element 84 which is formed at the housing bottom part 16 engages radially inwardly a corresponding radially outwardly open housing counter engagement element 86 in the region of the closed end disc 50 of the first ring filter element 26; in this regard, reference is being had to the above description and the FIGS. 13, 14, 15 as well as 20, 23.

Furthermore, the filter device 10.6 comprises a second housing positioning device 108, compare also FIG. 27. As in the filter device 10.5, a second housing engagement element 110 formed at the housing top part 14 engages radially outwardly a corresponding radially inwardly open housing counter engagement element 112 in the region of the open end disc 52 of the second ring filter element 28; in this regard, reference is being had to the above description and the FIGS. 20, 21, and 22. The second ring filter element 28 of the filter device 10.6 corresponds to the above described ring filter element 28 illustrated in FIG. 25.

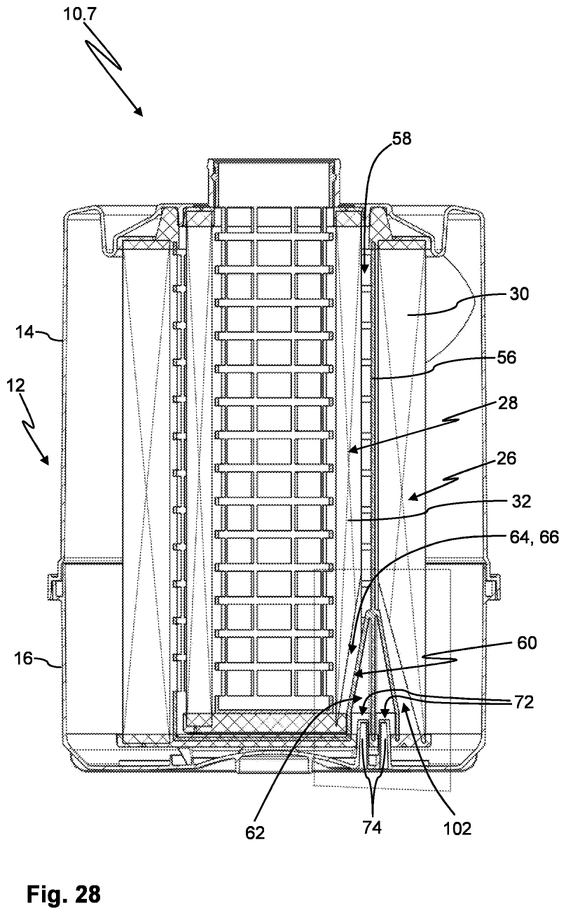

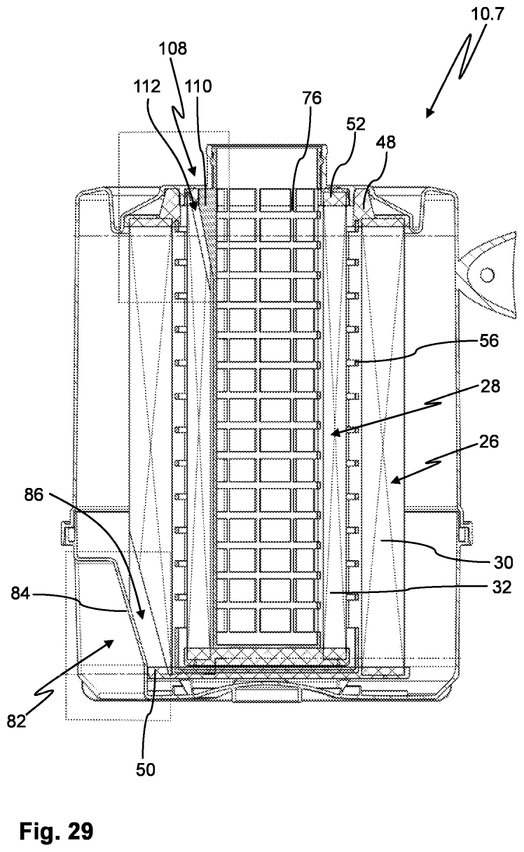

FIGS. 28 and 29 show a seventh filter device 10.7 which in many aspects corresponds to the filter device 10.5 of FIG. 20. In the following, primarily the differences will be explained; in other respects reference, is being had to the preceding description.

A positioning device 60 between the two ring filter elements 26, 28 is formed with an engagement element 62 in the form of a radially inwardly pointing projection at a central tube 56 fixedly connected to the outer ring filter element 26, compare FIG. 28. The engagement element 62 engages a counter engagement element 64 at the inner ring filter element 28 which here also is formed by a fold expansion 66 at the outer wall surface 42 of the second filter medium body 32 (compare in this regard also FIG. 5). At the engagement element 62, a radially outwardly pointing projection is formed in addition which engages a fold expansion 102 at the inner wall surface 40 of the first filter medium body 30. The engagement element 62 is provided with two end face cutouts 72, one each in the projections that are inwardly or outwardly protruding away from the central tube 56. Each one of the cutouts 72 is engaged by a respective axial projection 74 of the filter housing 12. Here, the axial projections 74 are formed as one piece together with the housing bottom part 16.

In addition, the filter device 10.7 comprises a first housing positioning device 82, compare FIG. 29. As in the filter devices 10.3 and 10.5, a first housing engagement element 84 which is formed at the housing bottom part 16 engages radially inwardly a corresponding radially outwardly open housing counter engagement element 86 in the region of the closed end disc 50 of the first ring filter element 26; in this regard, reference is being had to the above description and the FIGS. 13, 14, 15 as well as 20, 23.

Furthermore, the filter device 10.7 comprises a second housing positioning device 108, compare also FIG. 29. As in the filter device 10.5, a second housing engagement element 110 which is formed at the housing top part 14 engages radially outwardly a corresponding radially inwardly open housing counter engagement element 112 in the region of the open end disc 52 of the second ring filter element 28; in this regard, reference is being had to the above description and FIGS. 20, 21, and 22. The second ring filter element 28 of the filter device 10.7 corresponds to the above described ring filter element 28 which is illustrated in FIG. 24.

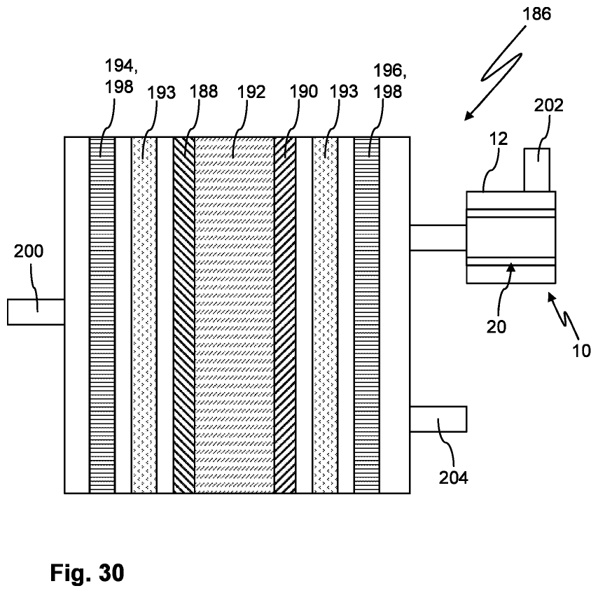

FIG. 30 shows a fuel cell 186. The fuel cell 186 comprises an anode 188, a cathode 190, and an electrolyte 192 arranged therebetween. The anode 188 and the cathode 190 may adjoin outwardly a gas diffusion layer 193, respectively. The anode 188 and the cathode 190 may be received between lateral parts 194, 196 of a bipolar plate 198. Through the lateral part 194 of the bipolar plate 198, hydrogen may be supplied from a hydrogen inlet 200 to the anode 188. Through the lateral part 196 of the bipolar plate 198, oxygen or air containing oxygen may be supplied from an air inlet 202 to the cathode 190. Between the air inlet 202 and the cathode 190, a filter device 10, for example, one of the above-described filter devices 10.1 to 10.7 with a ring filter element assembly 20 arranged in a filter housing 12, is provided. The filter device 10 functions thus as a cathode air filter. Water produced in the fuel cell 186 may be discharged through a water outlet 204. Electrical connections of the fuel cell 186 are not illustrated in detail.

In summary, the invention concerns a ring filter element assembly with two ring filter elements that may be flowed through serially (sequentially). An outer ring filter element surrounds an inner ring filter element at least in a subregion of its axial extension. A rotational position of the two ring filter elements relative to each other is fixed in that an engagement element which is arranged between the two ring filter elements engages in radial direction at least one of the ring filter elements. The engagement element may be held at a central tube which extends between the filter medium bodies of the ring filter elements. In one embodiment, the central tube is fastened to one of the ring filter elements and the engagement element engages the other ring filter element. In another embodiment, the engagement element engages both ring filter elements; the central tube may then be detachable in relation to the two ring filter elements and securable at a filter housing. One or both ring filter elements may comprise folded bellows. For example, the engagement element engages a spread-apart fold.

### REFERENCE CHARACTERS

filter device 10.1; 10.2; 10.3; 10.4; 10.5; 10.6; 10.7; 10
filter housing 12
housing top part 14
housing bottom part 16
ring filter element assembly 20
fluid inlet 22
fluid outlet 24
first or outer ring filter element 26
second or inner ring filter element 28
filter medium body 30 of the first ring filter element 26
filter medium body 32 of the second ring filter element 28
interior 34 of the first ring filter element 26
interior 36 of the second ring filter element 28
outer wall surface 38 of the first filter medium body 30
inner wall surface 40 of the first filter medium body 30
outer wall surface 42 of the second filter medium body 32
inner wall surface 44 of the second filter medium body 32
longitudinal axis 46a of the first ring filter element 26
longitudinal axis 46b of the second ring filter element 28
common longitudinal axis 46
open end disc 48 of the first ring filter element 26
closed end disc 50 of the first ring filter element 26
open end disc 52 of the second ring filter element 28
closed end disc 54 of the second ring filter element 28
central tube 56 of the first ring filter element 26
interface region 58
positioning device 60
engagement element 62
counter engagement element 64 of the second ring filter element 28
cutout 65 radially outward in the end disc 54
cutout 65′ radially outward in the end disc 52
fold expansion 66 at the outer wall surface 42 of the second filter medium body 32
radially outer fold edges 68 of the second filter medium body 32
fold angle 70
cutout 72
axial projection 74 at the filter housing 12
support tube 76
element-fixed central tube 77 of the second ring filter element 28
protruding radially inner fold edge 78a of the first filter medium body 30
radially inner fold edges 78b of the first filter medium body 30
projection 80 of the element-fixed central tube 56
first housing positioning device 82
first housing engagement element 84
first housing counter engagement element 86
fold expansion 88 at the outer wall surface 38 of the first filter medium body 30
cutout 90 radially outward in the end disc 50
radially outer fold edges 92 of the first filter medium body 30
fold angle 94
housing-fixed central tube 96
counter engagement element 98 of the first ring filter element 26
cutout 100 radially inward in the end disc 48
fold expansion 102 at the inner wall surface 40 of the first filter medium body 30
radially inner fold edges 104 of the first filter medium body 30
fold angle 106
second housing positioning device 108
second housing engagement element 110
second housing counter engagement element 112 at the second ring filter element 28
fold expansion 114 at the inner wall surface 44 of the second filter medium body 32
cutout 116 radially inward in the end disc 52
radially inner fold edges 118 of the second filter medium body 32
fold angle 120
sealing bead 122
depression 124
bulge 126
fuel cell 186
anode 188
cathode 190
electrolyte 192
gas diffusion layer 193
lateral parts 194, 196
bipolar plate 198
hydrogen inlet 200
air inlet 202
water outlet 204

That which is claimed is:

1. A ring filter element assembly comprising:
a first ring filter element comprising a first filter medium body surrounding a first interior;
a second ring filter element comprising a second filter medium body surrounding a second interior, wherein the second ring filter element is received at least partially in the first interior of the first filter medium body of the first ring filter element;
wherein an outer wall surface of the second filter medium body of the second ring filter element and an inner wall surface of the first filter medium body of the first ring filter element adjoin each other in an interface region;
a positioning device arranged in the interface region and configured to angularly position the first ring filter element and the second ring filter element relative to each other;
wherein the positioning device comprises an engagement element, wherein the engagement element extends radially outwardly and engages a first counter engagement element of the first ring filter element and/or the engagement element extends radially inwardly and engages a second counter engagement element of the second ring filter element.

2. The ring filter element assembly according to claim 1, wherein at least one of the first filter medium body and the second filter medium body comprises an adsorbent gas filter medium.

3. The ring filter element assembly according to claim 1, wherein the first filter medium body comprises a folded bellows comprising a plurality of folds, wherein the plurality of folds include at least one projecting fold projecting farther radially inwardly at the inner wall surface of the first filter medium body than adjoining folds of the plurality of folds adjoining the at least one projecting fold in a circumferential direction of the folded bellows, wherein the at least one projecting fold forms at least partially the engagement element of the positioning device and engages the second counter engagement element of the second ring filter element.

4. The ring filter element assembly according to claim 1, wherein the first ring filter element comprises a central tube arranged at the inner wall surface of the first filter medium body and fastened indirectly or directly to the first filter medium body, wherein the engagement element of the positioning device is arranged at the central tube, extends radially inwardly, and engages the second counter engagement element of the second ring filter element.

5. The ring filter element assembly according to claim 1, further comprising a central tube detachably arranged in the interface region and, in an intended mounting state of the ring filter element assembly in a filter housing, arranged fixedly at the filter housing, wherein the engagement element of the positioning device is arranged at the central tube and extends radially inwardly into the second counter engagement element of the second ring filter element and extends radially outwardly into the first counter engagement element of the first ring filter element.

6. The ring filter element assembly according to claim 1, further comprising a central tube arranged in the interface region, wherein the engagement element of the positioning device is formed at the central tube, wherein the central tube comprises an end face comprising a cutout configured to engage, in an intended mounting state of the ring filter element assembly in a filter housing, an axial projection of the filter housing.

7. The ring filter element assembly according to claim 6, wherein the cutout is formed in the engagement element of the positioning device.

8. The ring filter element assembly according to claim 1, wherein the first filter medium body of the first ring filter element comprises a folded bellows, and wherein the engagement element of the positioning device engages an intermediate space between two neighboring folds of the folded bellows at the inner wall surface of the first filter medium body of the first ring filter element.

9. The ring filter element assembly according to claim 8, wherein the intermediate space is a fold expansion between the two neighboring folds and forms the first counter engagement element.

10. The ring filter element assembly according to claim 1, wherein the second filter medium body of the second ring filter element comprises a folded bellows, and wherein the engagement element of the positioning device engages an intermediate space between two neighboring folds of the folded bellows at the outer wall surface of the second filter medium body of the second ring filter element.

11. The ring filter element assembly according to claim 10, wherein the intermediate space is a fold expansion between the two neighboring folds and forms the second counter engagement element.

12. The ring filter element assembly according to claim 1, wherein the first ring filter element comprises at least one first end disc seal-tightly delimiting the first filter medium body axially and/or wherein the second ring filter element comprises at least one second end disc seal-tightly delimiting the second filter medium body axially.

13. The ring filter element assembly according to claim 12, wherein the first counter engagement element comprises a cutout in the at least one first end disc of the first ring filter element, wherein the cutout in the at least one first end disc is aligned with a fold expansion of a folded bellows of the first filter medium body, wherein the cutout and the fold expansion together form the first counter engagement element.

14. The ring filter element assembly according to claim 12, wherein the second counter engagement element comprises a cutout in the at least one second end disc of the second ring filter element, wherein the cutout in the at least one second end disc is aligned with a fold expansion of a folded bellows of the second filter medium body, wherein the cutout and the fold expansion together form the second counter engagement element.

15. A filter device comprising:
a filter housing comprising at least one fluid inlet and at least one fluid outlet;
a ring filter element assembly according to claim 1 arranged in the filter housing and separating the at least one fluid inlet from the at least one fluid outlet.

16. The filter device according to claim 15, furthermore comprising a central tube fastened to the filter housing, wherein the engagement element of the positioning device of the ring filter element assembly is arranged at the central tube and extends from the central tube radially inwardly into the second counter engagement element of the second ring filter element and extends radially outwardly into the first counter engagement element of the first ring filter element.

17. The filter device according to claim 15, wherein the filter housing comprises a first housing positioning device configured to angularly position the first ring filter element in relation to the filter housing, wherein the first housing positioning device comprises a first housing engagement element extending radially inwardly and engaging a first housing counter engagement element of the first ring filter element.

18. The filter device according to claim 17, wherein the first filter medium body of the first ring filter element comprises a folded bellows, wherein the first housing engagement element engages an intermediate space between two neighboring folds of the folded bellows at the outer wall surface of the first filter medium body of the first ring filter element.

19. The filter device according to claim 17, wherein the filter housing comprises a second housing positioning device configured to angularly position the second ring filter element in relation to the filter housing, wherein the second housing positioning device comprises a second housing engagement element extending radially outwardly and engaging a second housing counter engagement element of the second ring filter element.

20. The filter device according to claim 19, further comprising a support tube fastened to the filter housing and engaging the second interior of the second filter medium body of the second ring filter element, wherein the second housing engagement element is arranged at the support tube.
